(19) United States
(12) Patent Application Publication
(10) Pub. No.: US 2026/0324682 A1
(43) Pub. Date: Oct. 22, 2026

(54) System and Method for Producing Protein Products on Commercial Scale

(71) Applicant: Blue Buffalo Enterprises, Inc., Wilton, CT (US)

(72) Inventors: William Russell Baer, Hamel, MN (US); Michael J. Blanchard, Farmington, AR (US); Christine Marie Dosch, Minneapolis, MN (US); Jason Herzog, Eden Prairie, MN (US); Benjamiin Robert Millis, Fridley, MN (US); Fabio Nierhoff, Minneapolis, MN (US); Hannah D. Powers, Minneapolis, MN (US); Marshall Marlyn Ryti, Elk River, MN (US); Goeran Walther, Plymouth, MN (US); James N. Weinstein, Maple Grove, MN (US)

(21) Appl. No.: 19/697,292

(22) Filed: Jun. 3, 2026

Related U.S. Application Data
(63) Continuation-in-part of application No. PCT/US2025/032085, filed on Jun. 3, 2025.
(60) Provisional application No. 63/655,405, filed on Jun. 3, 2024.
(60) Provisional application No. 63/817,023, filed on Jun. 3, 2025.

(51) Int. Cl. A23J 3/26; A23L 5/10; A23P 30/20; B01F 25/00; B01F 25/4314; B01F 35/21; B01F 35/90; B01F 35/93; B01F 101/06; G05D 23/19

(52) U.S. Cl. CPC A23J 3/26; A23L 5/10; A23P 30/20; B01F 25/4314; B01F 35/2115; B01F 35/93; G05D 23/1931; B01F 2025/917; B01F 2035/99; B01F 2101/06; B01F 2215/0422; B01F 2215/0459

(57) ABSTRACT

A system and method for producing, on a commercial scale, a plant or reconstituted meat based product including a main protein body by pumping a protein slurry through a heating device, includes a heated die passage through which the slurry is directed in a laminar fashion, with the slurry being heated along both inner and outer surfaces and directed along at least one helical vane extending within the annular die passage. As the slurry passes within the die passage, the at least one helical vane maintains a protein component of the slurry in suspension by limiting migration of fluid while the slurry transitions into a cooked protein product which flows out of a die head.

### CROSS REFERENCE TO RELATED APPLICATIONS

This application is a continuation-in-part of PCT/US2025/032085 filed, Jun. 3, 2025, which claims the benefit of No. 63/655,405 filed Jun. 3, 2024, and this application claims the benefit of U.S. provisional patent application No. 63/817,023 filed Jun. 3, 2025.

### FIELD OF THE INVENTION

The invention generally pertains to a system and method for producing, on a commercial scale, plant or meat-based protein products.

### BACKGROUND OF THE INVENTION

Animal or animal-based meats are relied upon as a protein source for many people. For others, meat analogues made with vegetarian or vegan ingredients are relied upon. Due to various production limitations, considerable efforts have been made in enhancing the commercial production of protein products. In particular, these efforts have resulted in significant advancements in the use of extrusion techniques in the production of protein products made from animal derived and/or non-animal derived protein sources. Considered important in producing these extruded products is the resulting products exhibiting characteristics, such as appearance and texture, similar to that of meat. Recent advancements have made this result possible, even at commercially acceptable rates. However, given the shearing during extrusion and cooling die operations employed with these known systems, there are limitations to the products being produced, particularly associated with the forced oil, fat and water separation.

### SUMMARY OF THE INVENTION

Provided herein is a system and method for producing, on a commercial scale, plant and/or meat (animal) based protein products exhibiting more traditional meat structures, including in both appearance and texture. The present invention specifically deviates from current mass production trends by not relying on extrusion production processes, for instance high shear single or twin screw cooking extrusion, but rather relies on the pumping of a protein slurry at a high rate through a heating device under laminar flow conditions. In a preferred embodiment of the invention, a vacuum supply unit is employed to pump the protein slurry to the heating device. The heating device includes a heated annular die through which the slurry is directed, enabling heating of the slurry along one or more of inner and outer radial surfaces while the slurry transitions into a heated protein product which flows out of the die. To assure uniform heating and assuring the quality of the resulting protein product, one or more sections of the annular die is provided with one or more internal vanes which force liquid components, including oil, fats and/or water, released from the intermediate product upon processing to be retained and/or reintroduced into the body during the production of the protein product. Overall, the system has been found to effectively produce protein product on a commercial scale, while offering advantages in terms of product quality, scalability, production rate and process control compared to traditional extrusion methods.

Additional objects, features and advantages of the invention will become more readily apparent from the following detailed description wherein like reference numerals refer to corresponding parts in the several views.

### BRIEF DESCRIPTION OF THE DRAWINGS

FIG. 1 is a flowchart illustrating the basic steps performed in accordance with an embodiment of the method of the invention.

FIG. 2 is a perspective view of a product flow system employed in connection with an embodiment of the invention.

FIG. 3 is a cross-sectional view of a portion of the product flow system of FIG. 2.

FIG. 4 is a perspective view showing a protein product being dispensed from the product flow system of FIG. 2.

FIG. 5 is a cross-sectional view of a portion of a product flow system constructed in accordance with another embodiment of the invention.

FIG. 6 is a cross-sectional view similar to FIG. 5 but illustrating the inclusion of a static twist unit in the product flow system.

FIG. 7 is a cross-sectional view of a portion of a product flow system constructed in accordance with a still further embodiment of the invention illustrating a static twist unit having four helical vanes in a rifling pattern.

FIG. 8 is a perspective view of the portion of the product flow system of FIG. 7.

FIG. 9 is a perspective view of a portion of a product flow system showing interconnected tubes.

FIG. 10 is a cross-sectional view of a portion of the product flow system shown in FIG. 9 showing a control system.

FIG. 11 is a cross-sectional view of a portion of a product flow system illustrating helical vanes formed in an outer conduit.

### DETAILED DESCRIPTION OF EMBODIMENTS

A protein product provided herein is produced by pumping a proteinaceous composition having a plant and/or meat based protein component, an optional additive component of at least one additional non-protein ingredient, such as a vegetable, a fluid component and, preferably, other additional ingredients, particularly one or more binders. The protein product provided herein typically has a protein content from about 45% to about 96%, preferably from about 65%-96% more preferably from about 70% to about 95.5%.

The present invention deviates from current mass production trends, particularly by not relying on high-shear extrusion production processes, but rather a non-disruptive low shear, high speed pumping with laminar flow of a protein slurry through a heating device to produce a high quality protein product on a commercial scale. As detailed below, in a preferred embodiment of the invention, a vacuum supply unit is employed to pump the protein slurry through the heating device. The heating device includes a heated annular die through which the slurry is directed, enabling heating of the slurry from one or both of inner and outer radial surfaces while the slurry transitions into a heated protein product which flows out of the die. To assure uniform heating and assuring the quality of the resulting protein product, one or more sections of the annular die is provided with one or more internal vanes which force fluids, such as in the form of oil, fat and/or water, released from the proteinaceous slurry or product during processing to be reintroduced into the body during the production of the protein product. As will become more fully evident below, the system has been found to effectively produce high quality protein product on a commercial scale.

As indicated above, the protein slurry, which has a batter, dough or other high viscosity consistency so could also be defined as a protein batter mix, includes at least a protein component established by at least one non-animal derived protein, animal derived protein, or mixtures thereof. A non-animal protein can be derived from any appropriate non-animal source (e.g., plant, algae, bacteria, fungi, yeast, and the like). Examples of non-animal derived proteins include, but are not limited to, crude mixtures of proteins (e.g., grain flour, legume flour, yeast extract, algae extract, and the like), or partially or fully purified proteins in the form of protein concentrates or protein isolates (e.g., zein, gluten, soy or pea protein isolate, soy or pea protein concentrate, and the like). An animal derived protein can be derived from any appropriate animal source (e.g., meat, egg, dairy, and the like) from any appropriate animal (e.g., poultry, bovine animals, pigs, horses, fish, sheep, goats, deer, and the like). Examples of animal derived proteins include, but are not limited to, crude mixtures of proteins (e.g., mechanically deboned meat, surimi, minced meat, meat paste, and the like), or partially or fully purified proteins (e.g., gelatin, casein, whey, albumin, milk protein isolate, and the like). An animal derived or non-animal derived protein for use in a process provided herein can be a derivative (e.g., isomer, hydrolysate, salt form) of a natural protein. An optional non-protein component can also be included, but not required. Such non-protein components can be constituted by numerous non-animal based ingredients, such as fruits, vegetables, cereals, legumes and the like. In addition, other additives can be incorporated in the slurry to adjust the viscosity, gelling properties, water binding properties, oil binding properties, solubility, emulsifying properties, cohesiveness, texture, flavor, aroma, color, appearance and/or the like. In some embodiments, these further additives can include, without limitation, a water component, a carbohydrate component, a lipid component, a pH adjusting agent, a flavoring agent, a coloring agent, a macronutrient, a micronutrient, a vitamin, a mineral, and the like. Table 1 below outlines a few exemplary product formulations:

TABLE 1

| Ingredient: | % | % | % | % | % |
|---|---|---|---|---|---|
| Chicken | 79.50 | 0.00 | 70.00 | 95.50 | 0 |
| Beef | | 75.00 | | 0.00 | 95.50 |
| Water | 0.00 | 0.00 | 2.00 | 2.00 | 2.00 |
| Grain | 4.00 | 4.00 | 5.00 | 0.00 | 0.00 |
| Plant Protein | 4.00 | 7.00 | 8.00 | 0.00 | 0.00 |
| Binder | 9.00 | 10.50 | 9.50 | 0.00 | 0.00 |
| Phosphate | 0.50 | 0.50 | 0.50 | 0.50 | 0.50 |
| Flavor | 1.00 | 1.00 | 3.00 | 0.00 | 0.00 |
| Salt | 2.00 | 2.00 | 2.00 | 2.00 | 2.00 |
| Ingredient Total: | 100.00 | 100.00 | 100.00 | 100.00 | 100.00 |

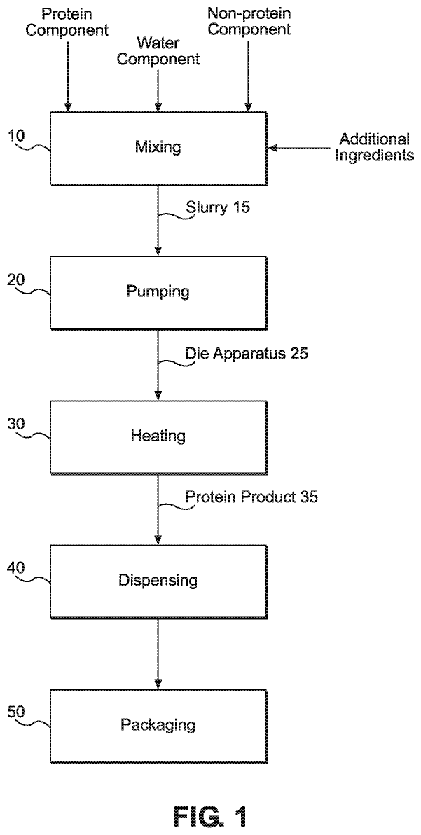

With particular reference to the flowchart of FIG. 1, the basic flow parameters for the production process of the invention are shown. Initially, a protein component, an optional non-protein component and potentially a water component, as well as various other optional ingredients, as referenced above, are mixed in step 10. This mixing operation is preferably conducted in an automated process, such as with a batch mixing apparatus commonly known in the art, to produce a slurry 15 which is then pumped at step 20 to a die apparatus 25. The slurry 15 is heated as it flows, in a laminar manner, through die apparatus 25 as represented by step 30. Although the pumping operation can be performed in various ways and with different types of equipment to create a stream comprising a proteinaceous composition, it is preferable to employ vacuum pumping, particularly using a Vemag™ device made by Vemag Maschinenbau GmbH, to ensure a consistent pressure/volume controlled flow. Optionally, a flow divider or flow restrictor can be installed between the pump and the heating device to control and maintain a balanced product flow across the cross-section of the heating device. Upon completing heating step 30, a protein product 35 in accordance with the invention is produced and dispensed at 40, after which the protein product 35 can be suitably further processed and packaged as represented by step 50.

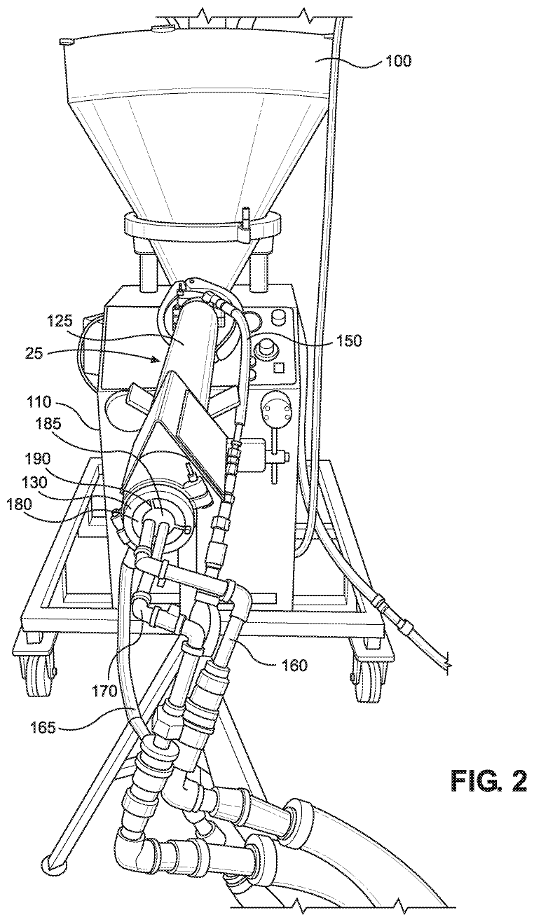

As indicated above, a known vacuum pumping unit is preferably employed in connection with the basic pumping step 20. This unit is shown best in FIG. 2, including a supply hopper 100 and a base control unit 110. Important to the invention is the modification to this known pumping unit wherein, at an outlet of this device, there is mounted die apparatus 25 including an elongated tube 125 into which slurry 15 is introduced and in which heating step 30 is performed. As will be detailed more fully below, tube 125 defines an annular flow channel for heating slurry 15. More specifically, the annular flow channel has both inner and outer jackets or pathways for the flow of a heating medium along the channel, thereby establishing an overall heated annular die. As shown in this figure, an outer jacket heating medium return line 150 is fluidly connected to an outer jacket heating medium supply line 165, while an inner jacket heating medium supply line 160 is fluidly connected to an inner jacket return line 170, to provide a continuous flow of a heating medium for performing the heating necessary to produce protein product 35. Once the components of slurry 15 are heated and congealed, dispensing step 40 for protein product 35 occurs from die head 130, which can be integrally formed with tube 125 or, more preferably, constituted by an insert secured to tube 125. In the embodiment shown, protein product 35 is dispensed through a plurality of openings, one of which is indicated at 180, with the various openings 180 being circumferentially spaced about a central plate 185 connected by a plurality of thin radial supports 190.

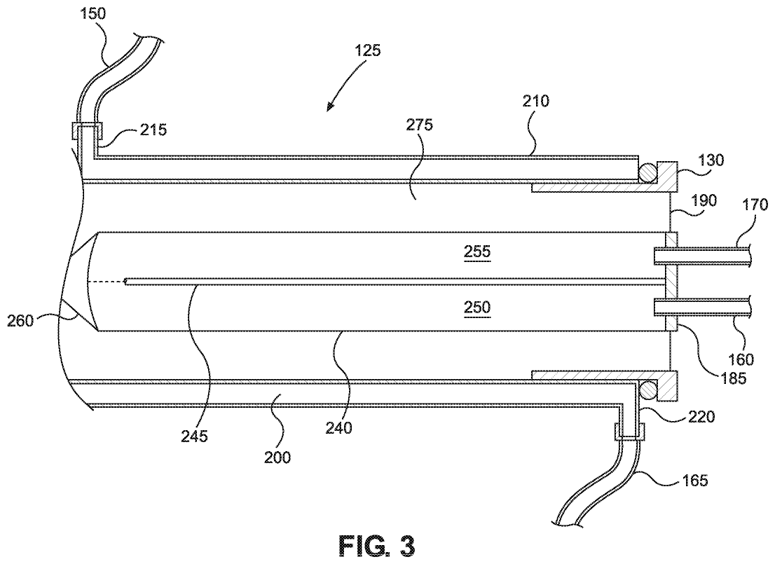

FIG. 3 shows a cross-section of a portion of elongated tube 125. Tube 125 is defined by an outer conduit 200. In accordance with the invention, outer conduit 200 is provided with an outer jacket 210, preferably extending annularly about outer conduit 200. Outer jacket 210 includes an outlet port 215 to which return line 150 is attached, and an inlet port 220 to which supply line 165 is attached. In the embodiment shown, outlet and inlet ports 215 and 220 are spaced at basically opposite ends along the length of tube 125. Within the confines of outer jacket 210 is provided an interior, close-ended conduit 240 having an internal divider 245 which establishes an inner jacket with an inlet passage 250 leading to a return passage 255. Fluidly connected to inlet passage 250 is supply line 160 and fluidly connected to return passage 255 is return line 170.

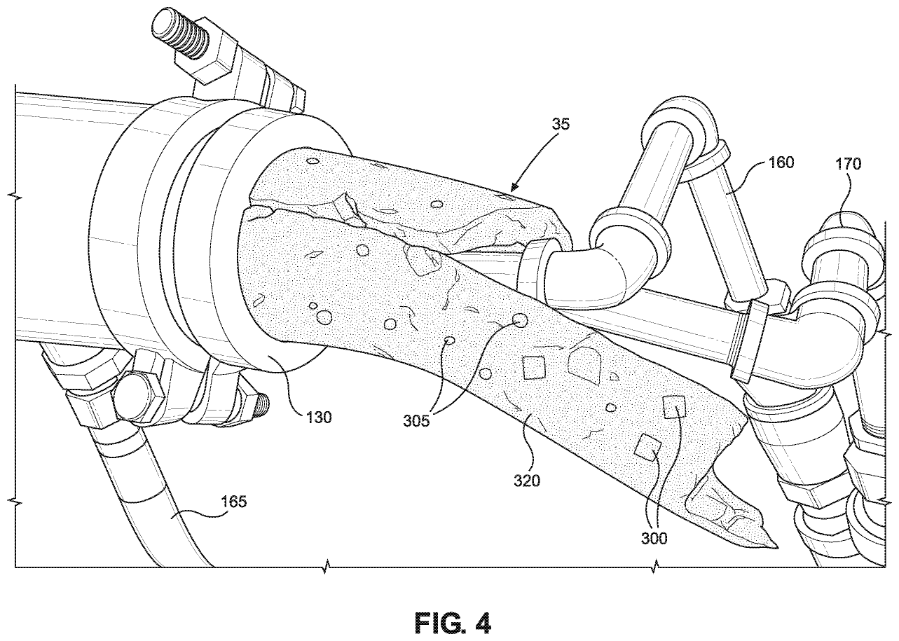

As shown, interior conduit 240 includes a conical portion 260 remote from central plate 185. With this construction, within outer conduit 200 is established an annular die passage 275 into which slurry 15 is pumped. Although not separately labeled in FIG. 3, in the embodiment depicted, die head 130 constitutes a separate component having an annular sleeve extending into and attached to outer conduit 200 by clamps 201 (shown in FIG. 4), while an O-ring is interposed between outer jacket 210 and die head 130.

During operation, slurry 15 is pumped into tube 125 and, beyond conical portion 260, flows into annular die passage 275, thereby being directly exposed to both outer jacket 210 and interior conduit 240. At the same time, a heated fluid medium, such as hydraulic fluid, is caused to flow through both outer jacket 210 and interior conduit 240. More specifically, for outer jacket 210, a heated fluid medium is introduced at inlet port 220 through supply line 165, with the heated fluid medium being forced to flow annularly through outer jacket 210 toward outlet port 215 and return line 150. This fluid is then re-heated and recycled in a controlled manner. In this way, slurry 15 is heated within annular die passage 275 through outer jacket 210. At the same time, a similar heating operation occurs along the interface between slurry 15 and interior conduit 240, with a heated fluid medium being introduced through supply line 160 to flow through inlet passage 250 and then return passage 255, before exiting return line 170 for re-heating and recycling. In this manner, due to the annular die passage 275 being exposed to both inner and outer radial heating sources, an inner and outer heated annular die arrangement is advantageously established to provide for high-capacity production of protein product 35.

The actual temperature and/or viscosity of the product stream within annular die passage 275 can be modified to adjust flow behavior, flow balance, or other stream properties, such as heating rate, gelling, setting, and structure formation, etc. in the die depending on the product being produced. For example, a stream can have a temperature from about 20 °C to about 210 °C (about 69-410 °F). In some embodiments, a stream can have a temperature from about 100 °C to about 150 °C (about 212-302 °F). In other embodiments, a stream can have a temperature from about 50 °C to about 160 °C (about 122-320 °F), from about 70 °C to about 145 °C (about 158-293 °F), or the like. In addition, the radial dimension of flow passage 275 can vary, preferably in the range of approximately 3-15 mm. It should also be recognized that the inner radial and the outer radial heating streams can be readily established to heat at different temperatures, with separate heated fluid streams or a known heated fluid supply with multiple flow paths. Furthermore, other heat sources instead of fluid heat sources could be employed. In any case, important in connection with the invention is the ability to retain the laminar flow of the slurry and forming protein product throughout the process. In some embodiments, the system operates in a creeping flow regime at a Reynolds number in the range of about 0.001 to about 10, more preferably in the range of about 0.001 to about 1, and most preferably at about 0.005. The Reynolds number can be used to define the operational window and distinguish between laminar and turbulent flow conditions, with the laminar flow being important for maintaining the desired protein fiber alignment and minimizing shear forces during processing. In addition, as will be detailed below, it is desired to assure the quality of the resulting protein product, particularly by controlling operational cooking temperatures and reintroducing any water or fat released by the protein body during heating back into the body such that the system has a very high yield.

As depicted, protein product 35 is dispensed about supply line 160 and return line 170 in the embodiment of FIG. 4. In this particular embodiment, protein product 35 happens to be shown with the inclusion of non-protein components in the form of chunks of the additional ingredient(s), such as carrots 300 and peas 305, which are clearly visually distinguishable from the main proteinaceous body 320 mainly based on the laminar and non-shear flow characteristics of the system, particularly due to the lack of any rotating parts in die passage 275.

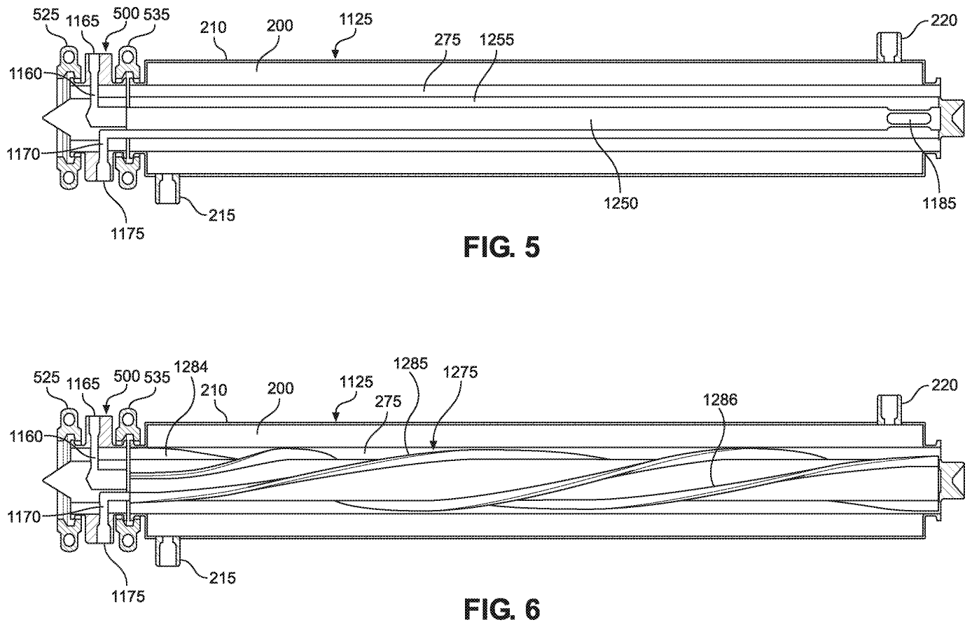

FIG. 5 shows a structural variation wherein internal radial conduits are employed to enable the repositioning and reorientating of these supply and return lines. Basically, a flow adapter 500 is interposed between the vacuum pumping unit and the tube 1125. More specifically, a first clamp 525 is used to fix flow adapter 500 to the vacuum pumping unit and a second clamp 535 is used to secure flow adapter 500 to tube 1125. With like reference numerals to the FIG. 3 arrangement, tube 1125 includes corresponding outer jacket 210, outer conduit 200, inlet port 215, outlet port 220 and annular die passage 275 structure. However, instead of employing inlet and return passages 250 and 255 separated by internal divider 245, tube 1125 includes additional concentric passages, i.e., a centrally concentric inlet passage 1250 and a return passage 1255 directly concentric to annular die passage 275, i.e., between inlet passage 1250 and annular die passage 275. Inlet passage 1250 is in fluid communication with a supply line 1160 having a supply port 1165 built into flow adapter 500, while return passage 1255 is in fluid communication with a return line 1170 and a return port 1175. With this arrangement, heating fluid is introduced into supply line 1160 through a hose or the like (not shown) at supply port 1165 to travel substantially the entire length of tube 1125, then is redirected at a connecting port 1185 to flow out through return passage 1255, then return line 1170 and return port 1175. This overall arrangement still provides for the plurality of ports 180 (basically an annular output opening aside from the thin supports 190 as referenced in FIG. 2).

As indicated above, it is desired to assure the quality of the resulting protein product 35 which, in accordance with the invention, requires a provision to reintroduce liquids, such as in the form of oil, fat and/or water released from the proteinaceous slurry or product during processing, back into proteinaceous body 320 during the production of protein product 35. To this end, FIG. 6 illustrates the inclusion of a static twist unit 1275 provided within die passage 275. Static twist unit 1275 includes at least one helical vane, with two such vanes 1285 and 1286 shown extending within die passage 275 to establish a static spiraling passage for the proteinaceous slurry 15, with the at least one helical vane keeping the protein component in suspension by limiting migration of fluid in forming the protein product. Again, it is desired in accordance invention to retain juices and other fluids in the protein component, including oils, fats and water, throughout the entire process so there is minimal loss of any liquids by evaporation or at the exit die openings 180 thereby assuring a quality product and a high yield, i.e., an overall yield of about 90-100%, more preferably 95-100% and, most preferably, a near 100% yield, meaning in the range of 97-100% (note “about” means±5% when used throughout the written description). This yield is established by the vanes 1285, 1286 countering the effect that, as the slurry 15 travels within annular die passage 275, there is a tendency for some fluids (particularly oil, fat and water) to be released from the protein component and other components and flow to the bottom of die passage 275. While also changing the fluid level of the protein component, these fluids can act as an insulator to effective heating of slurry 15. However, the inclusion of the static twist unit 1275 effectively prevents fluid pooling, with the flowing protein component continually directly the fluids along a respective vane 1285, 1286 to enhance channeling and product temperature gradient, while not negatively affecting the laminar flow characteristics for the proteinaceous slurry 15, thereby enabling the high yield for the system. With respect to the temperature gradient, one test embodiment employing a dual vane arrangement in a single heating zone translated into a product temperature gradient in the range of 4.7-5.1 °C (8.4-9.1 °F) with the inclusion of static twist unit 1275 versus a product temperature gradient of 10.3-11.9 °C (18.6-21.5 °F) without the use of static twist unit 1275. Certainly, the number of vanes, the angle and/or direction of twist and the mounting of the overall structure, either as an integral element per tube or inserts having vanes interconnected by various radial supports, can vary in accordance with the invention. For instance, a single 180° twist for one cook zone can be followed by a 360° twist multi-vane arrangement in a subsequent zone. Alternatively, at least one 60° twist or at least three 60° twists could be in a single cook zone.

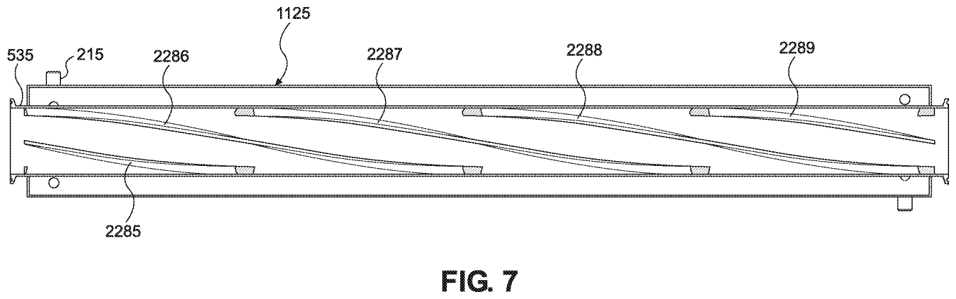

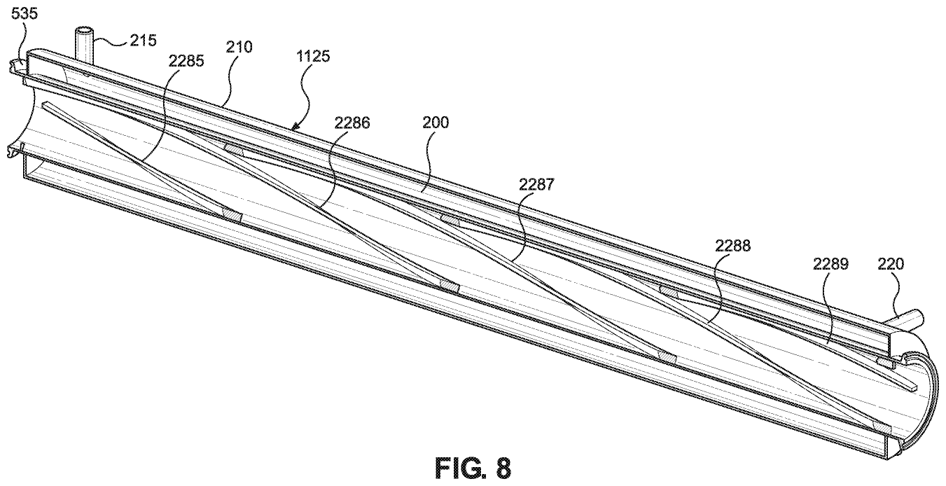

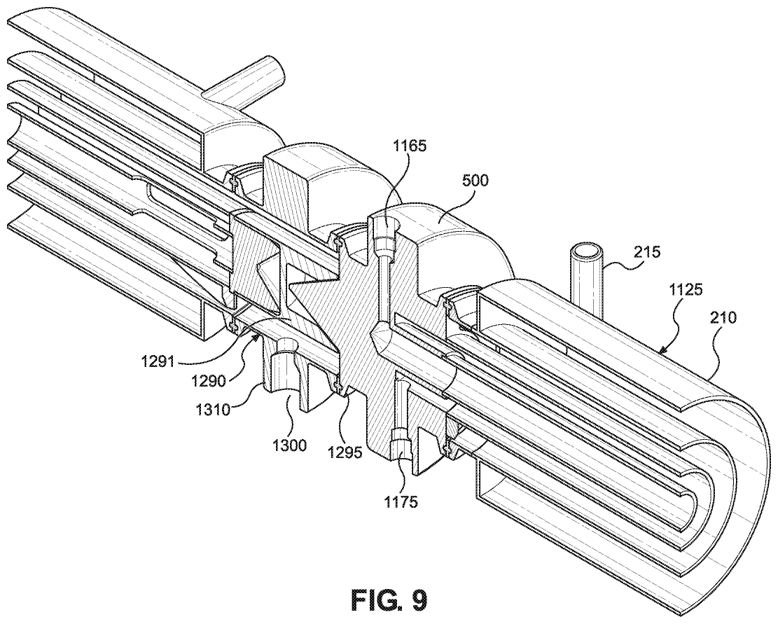

FIGS. 7 and 8 illustrate a further embodiment of the static twist unit wherein several helical vanes 2285, 2286, 2287, 2288 and 2289 extend radially inwardly within die passage 275 of tube 1125 to establish a rifling configuration. As the diameter and or length of the equipment increases, additional vanes may be employed to properly influence the proteinaceous slurry flowing through the die passage 275. The multi-vane arrangement shown in FIG. 8 provides enhanced fluid distribution and temperature uniformity across the larger cross-sectional area of the die passage 275, while maintaining the laminar flow characteristics and fluid retention benefits described above in connection with the two-vane embodiment. While the embodiment in FIGS. 7 and 8 show a rifling configuration with the vanes extending radially inward, the vanes could be mounted on an inner surface and extend radially outward as shown in FIG. 6.

In addition to changing the internal heating configuration for the tube, the length of the heating and food product dispensing system can be varied, such as to further control the heating/cooking parameters for the product. That is, an elongated tubing system could be employed with multiple heating zones or two or more modular heating units could be employed along the length of the overall tubular cooking assembly to establish separate heating circuits which can operate at different temperatures. The modular heating units could also provide one or more heating paths to and from the cooking zone. This could be important depending on the composition employed, for instance to address potential water/steam flash off upon exiting which could lead to undesirable product expansion. Therefore, it is considered desirable to initially heat the composition to a high temperature to accelerate heat transfer and allow higher rates, while a subsequent heat circuit would condition the product down to desired exit temperatures and prevent flash off. By way of example, product exit temperatures could be established at or just above 85 °C (185 °F), more preferably between about 85 °C-93 °C (185-199.4 °F).

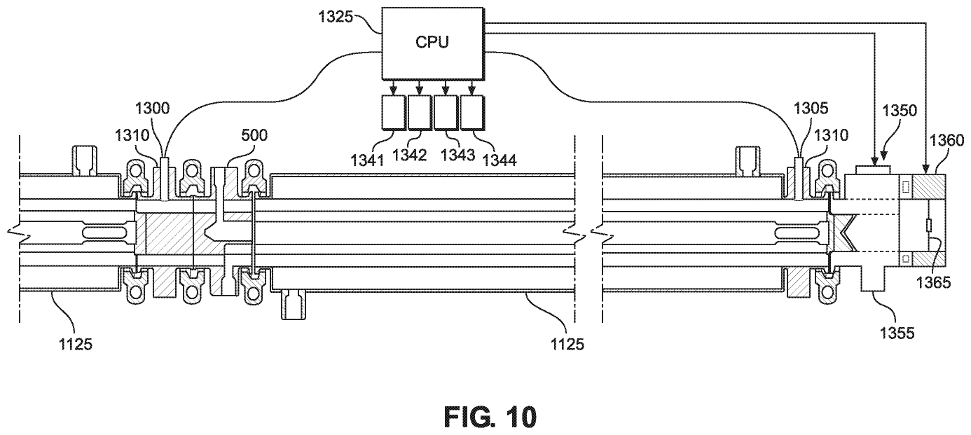

FIGS. 9 and 10 illustrates an exemplary configuration wherein multiple heating tubes 1125 are interconnected to establish successive heating stages for the protein mass. Although the number could certainly vary, the FIG. 10 embodiment conveys how successive tubes 1125 can easily be clamped directly together to extend the overall tube length. This interconnection can be done in various ways, such as with two identically constructed tubes 1125 connected through another, interposed flow adapter 500 and multiple clamps (not separately labeled). In this fashion, multiple successive heating or cooking stages can be created for operation at different temperatures, such as particularly set forth below with reference to the mass production of a particularly preferred product. In addition, although not shown but referenced herein, the heating stages could be followed by one or more cooling stages for the resulting product.

FIG. 9 illustrates a perspective view of an alternative connector hub 1290 of the product flow system of FIG. 8 showing interconnected tubes 1125 with flow adapters 500. The interconnected tubes 1125 are joined with the connector hub 1290 which does not require additional supports. A core adapter 1291 is provided in the connector hub 1290. The connector hub 1290 is attached to the interconnected tubes 1125 by sanitary fittings 1295. Temperature sensing inserts 1310 are provided along the tubes 1125 for receiving temperature sensors 1300 to monitor the temperature of the protein product as it flows through the system. Supply port 1165 and return port 1175 are also shown for the inner heating fluid circuit. This arrangement enables precise monitoring and control of the cooking process along the length of the interconnected tubes 1125.

In connection with the overall food production process, FIG. 10 illustrates numerous additional features of the overall invention. At this point it should be noted that vanes 1285 and 1286 are not shown in FIG. 10 but yet all of the control features discussed below are preferably employed in combination with the use of one or more of such vanes. As depicted, various thermocouples or other temperature sensing elements, such as sensors 1300 and 1305, can be provided along each tube 1125, such as at spaced temperature sensing inserts 1310 to measure food product temperatures, with the sensors 1300 and 1305 being linked to a controller or CPU 1325 employed in connection with controlling the inner and outer radial operational heating temperatures along the length of the tubes 1125 through separately regulated heat flow controllers 1340-1344. In this fashion, the desired cooking conditions can be effectively and precisely controlled as the protein mass moves through the system. That is, the temperature and/or rate of the heating fluid delivered to the inner and outer concentric passages can be separately controlled for each tube 1125. FIG. 10 also illustrates the inclusion of a dump valve 1350, exemplarily shown mounted just prior to protein product 35 being dispensed. Dump valve 1350 is also preferably linked and controlled through CPU 1325. Since the invention is preferably employed in mass producing food for human or pet consumption, including fresh, dumping product which is not being produced according to set standards as measured through the use of the temperature sensors are advantageous control features. Certainly, various dump valves could be provided at strategic locations from the start of the tube to along the overall length thereof with, by way of example, the dump valve 1350 just prior to the dispensing location for the food product being advantageously, automatically activated to redirect food product to a secondary outlet 1355 which has not reached a desired cooking temperature during production.

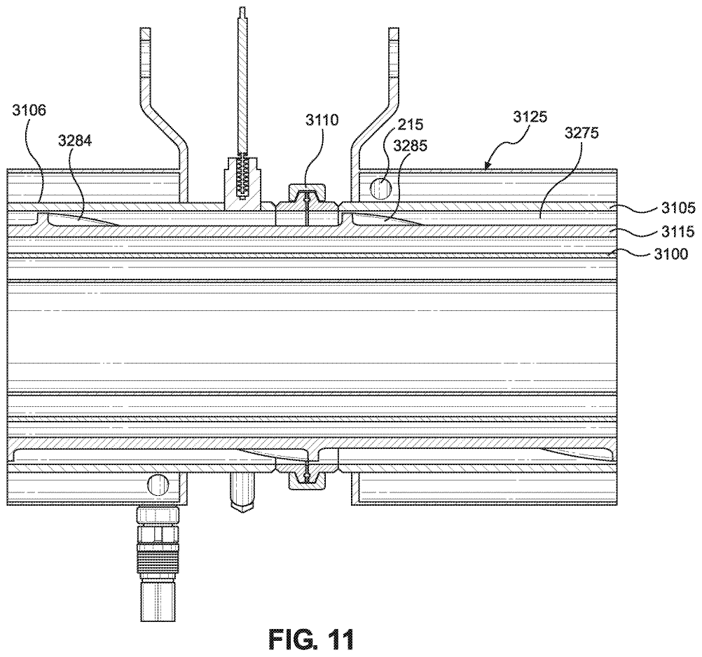

FIG. 11 illustrates an alternative embodiment with a housing wherein, helical vanes protrude into a die passage 3275, and one or more helical channels or grooves are formed between vanes in the die passage 3275. In this embodiment, no connector hub is employed due to the presence of a single core 3100, which is longer than the cores employed in the other embodiments described above and may preferably be about 12 feet long, although other lengths are also desirable. A first outer housing 3105 is joined to a second outer housing 3106 through a sanitary fitting 3110. As shown, helical channels formed by ridges or vanes 3284 and 3285 extend along the inner surface of tubular wall 3115 within passage 3275, with a static twist unit 3125 being established by the vanes 3284 and 3285. This arrangement induces a twisting motion in the proteinaceous slurry as it flows through die passage 3275, thereby achieving similar fluid distribution and temperature uniformity benefits as the protruding vane embodiments while providing an alternative structural configuration. The vanes can be formed with various pitches and numbers of channels depending on the diameter of the equipment and the characteristics of the proteinaceous slurry being processed.

Regardless of the number of heating stages or exact heat assembly configuration, upon exiting the system, the dispensed protein product 35 is ready to be further processed, including any desired sizing, including cutting, shredding or the like, such as with the inclusion of a cutting unit 1360 having a rotating blade unit 1365 at the outlet. Thereafter, the protein product 35 can be cooled and further processed or packaged. Certainly, a wide range of food items can be made with the system and method detailed above, such as the production of protein pieces for soups, toppings for frozen pizzas, and the like.

By way of a particular example, a high protein product (i.e., a protein content of from about 70% to greater than 95%) is made having one or more main protein component(s), such as from chicken, beef and/or fish (again note exemplary formulations set forth in Table 1 above). Initially, the various components are mixed as discussed above to form a slurry having an effective viscosity due to the addition of a binder to establish a balanced, laminar flow within the system during which, with the channeling of the proteinaceous slurry, the proteins become aligned which advantageously enhances overall product texture. Using an exemplary, multi-stage cooking operation, the temperatures are controlled to establish different cooking stages in successive tube sections. For instance, a first cooking zone can be operated at between about 87.8-148.9 °C (190-300 °F) and then a second cooking zone can be created to establish a food appropriate exit temperature, i.e., less than 87.8 °C (190 °F), such as about 72.2-76.7 °C (162-170 °F) or lower, even down to 15.6 °C (60 °F). Therefore, multiple cooling sections can be provided to enable a smoother cooling of the product to a temperature well below the 87.8 °C (190 °F) mark, such as down to about 37.8 °C (100 °F), or even down to 15.6 °C (60 °F), prior to reaching the die exit. This particular arrangement was found to provide a few further benefits, including enhanced liquid absorption by the food prior to the die exit, retention of a striated meat-like structure, and an overall food cohesiveness advantageous to the cutting operation. The targeted exit temperature can be established based on boiling point to avoid steam flashing off and potential product blow out. Certainly, the residence time/rate in the die will affect the overall cooking, but it should be noted that the invention can be advantageously employed to produce the cooked high protein food product at a rate of even up to about 2268 kg/hr (5000 lbs/hr), more preferably between 363-2268 kg/hr (800-5000 lbs/hr), with a particularly effective rate being in the range of about 907 kg/hr (2000 lbs/hr). In other embodiments, three heating sections/zones were employed, including a first slow heat zone to establish the desired laminar flow, desired drag flow against the annular die passage wall and improved striation, followed by second and third heating zones for complete cooking of the meat. Thereafter, the food mass would proceed through the two cooling zones in which the temperature is gradually decreased while maintaining a balanced flow and retaining available fluids in the product. In one tested embodiment, such a long die can effectively be operated with low back pressure, e.g., less than 689.5 kPa (100 psi). To this end, pressure sensors could also be incorporated into the system, preferably with signals being sent to the controller, for regulating internal section pressures. In connection with the laminar flow conditions referenced herein, laminar flow is defined as any flow having a Reynolds number less than about 2300.

Although described with reference to preferred embodiments of the invention, it should be understood that various changes and/or modifications can be made without departing from the invention as encompassed by the scope of the following claims. That is, from the description given, it will be appreciated that the invention can be practiced with embodiments other than those disclosed such that the disclosed embodiments are presented for purposes of illustration and not limitation. For instance, although illustrating tubes, conduits, passages, channels, etc., which are annular or generally circular in cross-section, it should be understood that various other geometric configurations could be employed. In any case, the present invention can take various forms in connection with commercially mass producing a wide range of meat and meat-like products through controlled laminar flow pumping, heating, and fluid regulating (i.e., minimal evaporation and overall fluid loss) conditions in a high yield rate manner. Overall, the system can be configured to produce various protein products by adjusting parameters like temperature, viscosity, and ingredient composition, while multiple heating and cooling zones can be incorporated for precise control over the cooking process.

What is claimed is:

1. A system for producing protein products comprising:
a mixer for receiving a protein component and at least one additional component to establish a proteinaceous slurry;
at least one tube including:
an annular die passage for a flow of the proteinaceous slurry;
a static twist unit extending within the die passage to establish a static spiraling passage for the proteinaceous slurry;
at least one of outer and inner heat channels in conductive heat transfer relation with the die passage for heating the proteinaceous slurry;
a pump; and
at least one opening leading from the annular die passage wherein, in operation, the system is configured to heat the proteinaceous slurry directed by the pump through the die passage to convert the proteinaceous slurry into a protein product, with the static twist unit keeping the protein component in suspension by limiting migration of fluid in forming the protein product, and dispense the protein product through the at least one opening.

2. The system of claim 1, wherein the system is designed to have a yield of about 90-100%.

3. The system of claim 2, wherein the system is designed to have a yield of about 95-100%.

4. The system of claim 3, wherein the static twist unit includes rifling extending within the annular die passage.

5. The system of claim 1, wherein the system is configured to operate under laminar flow conditions.

6. The system of claim 5, wherein the system is configured to operate under laminar flow with a Reynolds number of about 0.001 to 10.

7. The system of claim 6, wherein the system is configured to operate under laminar flow with a Reynolds number of about 0.001 to 1.

8. The system of claim 5, which is void of a high shear single or twin screw extruder during cooking.

9. The system of claim 1, wherein the static twist unit includes at least one vane that twists at least 60° within the die passage.

10. The system of claim 9, wherein the at least one vane twists at least 180° within the die passage.

11. The system of claim 10, wherein the at least one vane twists at least 1080° within the die passage.

12. The system of claim 1, wherein the system includes both the outer heat channel and the inner heat channel, with one or more heated fluid mediums being configured to be directed through the inner heat channel and the outer heat channel to cook the proteinaceous slurry.

13. The system of claim 12, wherein the at least one tube includes multiple successive heating sections followed by at least one cooling section.

14. The system of claim 1, wherein the at least one tube includes at least first and second tube sections which are interconnected and provide distinct product heating zones.

15. The system of claim 14, further comprising:
at least first and second temperature sensors configured to sense temperatures of the protein product in the first and second tube sections, respectively; and
a controller configured to receive temperature signals from the first and second temperature sensors for use in controlling the system.

16. The system of claim 15, wherein the system is configured to produce cooked protein product at a rate in a range of 363-2268 kg/hr.

17. A method of producing cooked protein products comprising:
pumping a proteinaceous slurry into a die passage of at least one tube of a die apparatus;
heating the slurry, as the slurry passes within the die passage, from at least one of outer and inner heat channels in conductive heat transfer relation with the die passage to convert the slurry into a protein product;
directing the slurry along a static twist unit extending within the die passage as the slurry passes within the die passage, with the static twist unit keeping a protein component of the slurry in suspension by limiting migration of fluid in forming the protein product; and
dispensing the protein product.

18. The method of claim 17, further comprising performing the method at a yield of between about 90-100%.

19. The method of claim 18, further comprising performing the method at a yield of between about 95-100%.

20. The method of claim 18, wherein the static twist unit includes rifling extending within the die passage.

21. The method of claim 17, further comprising creating a laminar flow of the slurry throughout the die passage of the at least one tube.

22. The method of claim 21, further comprising creating a laminar flow of the slurry with a Reynolds number of about 0.001 to 10 throughout the die passage of the at least one tube.

23. The method of claim 22, further comprising creating a laminar flow of the slurry with a Reynolds number of about 0.001 to 1 throughout the die passage of the at least one tube.

24. The method of claim 17, wherein the static twist unit includes at least one helical vane extending within the die passage causing the slurry to twist through at least 60° upon flowing through the at least one tube.

25. The method of claim 24, wherein the slurry twists through at least 180° upon flowing through the at least one tube.

26. The method of claim 25, wherein the slurry twists through at least 1080° upon flowing through the at least one tube.

27. The method of claim 17, further comprising heating the slurry from both the outer heat channel and the inner heat channel, with one or more heated fluid mediums being configured to be directed through the inner heat channel and the outer heat channel to cook the slurry.

28. The method of claim 17, wherein the at least one tube includes multiple successive heating sections followed by at least one cooling section, with the slurry being heated and cooled during flow through the die apparatus.

29. The method of claim 17, further comprising heating the slurry within distinct product heating zones of the at least one tube, with the distinct product heating zones being established by at least first and second tube sections of the at least one tube.

30. The method of claim 29, further comprising:
sensing temperatures of the protein product in the first and second tube sections with first and second temperature sensors, respectively; and
controlling operation of the die apparatus based on temperature signals received from the first and second temperature sensors.

31. The method of claim 17, wherein the method produces cooked protein product at a rate in a range of 363-2268 kg/hr.

32. The method of claim 17, wherein the slurry is a proteinaceous slurry and has a protein content from about 45% to about 96%.
